(19) United States
(12) Patent Application Publication
(10) Pub. No.: US 2006/0291914 A1
(43) Pub. Date: Dec. 28, 2006

(54) Image forming apparatus

(75) Inventor: Kazuko Fukumoto, Osaka (JP)

Correspondence Address: BRINKS HOFER GILSON & LIONE, P.O. BOX 10395, CHICAGO, IL, 60610, US

(73) Assignee: KONICA MINOLTA BUSINESS TECHNOLOGIES, INC.

(21) Appl. No.: 11/455,357

(22) Filed: Jun. 19, 2006

(30) Foreign Application Priority Data
Jun. 28, 2005 (JP) JP2005-187955

(51) Int. Cl. G03G 15/16

(52) U.S. Cl. 399/319

(57) ABSTRACT

An image forming apparatus capable of providing a sufficient vibration based on the natural frequency of the components of the transfer section and providing adequate control for this purpose, thereby enhancing and maintaining the transfer efficiency. The aforementioned image forming apparatus includes a vibration application device for applying vibration to at least one of the transfer source member and the transfer destination body; and a vibration control section for controlling the vibration given by the aforementioned vibration application device so as to change the vibration frequency in the predetermined range containing the natural frequency of the aforementioned transfer source member or the aforementioned transfer destination body to which vibration is applied by the aforementioned vibration application device during the transfer of toner from the aforementioned transfer source member to the aforementioned transfer destination body.

This application is based on Japanese Patent Application No. 2005-187955 filed on Jun. 28, 2005, in Japanese Patent Office, the entire content of which is hereby incorporated by reference.

### Technical Field

The present invention relates to an image forming apparatus, particularly to an image forming apparatus including a transfer source member for carrying a toner image and a transfer destination body for receiving the toner image transferred from the transfer source member.

### BACKGROUND

In the image forming apparatus based on electrophotographic technology, an electrostatic latent image formed on a photoreceptor is developed by toner and the toner image is transferred onto a recording sheet, whereby an image is formed. When the apparatus is equipped with an intermediate transfer member, the toner image is primarily transferred from a photoreceptor to an intermediate transfer member, and is secondarily transferred from the aforementioned intermediate transfer member to a recording sheet where an image is formed.

An electrostatic transfer method is generally used in the transfer process of the image forming apparatus described above. For example, when the toner image on the photoreceptor is primarily transferred to the intermediate transfer member, voltage is applied to a transfer member arranged face to face with the photoreceptor with the intermediate transfer member located in-between so that an electric field is formed between the photoreceptor and intermediate transfer member. This electric field allows the toner image to be electrostatically adsorbed by the intermediate transfer member.

In the aforementioned transfer process, if the electric field is disturbed or there is excessive adhesion of the toner onto the photoreceptor, part of the toner remains on the photoreceptor without being transferred, with the result that transfer efficiency will be reduced.

A technique of removing the remaining toner is disclosed, for example, in Japanese Laid-Open Patent Publication No. H5-313539 wherein an ultrasonic wave is applied to the remaining toner to cause vibration. This makes it easy to remove toner from the photoreceptor. Then a cleaner blade is used to remove the toner.

Improvement of the technique of removing the remaining toner is desirable, but what is more important is to enhance the transfer efficiency. Enhanced transfer efficiency reduces the amount of the remaining toner. This reduces the load of removing the remaining toner, and also reduces the possibility of image degeneration caused by so-called dropout (hole-like partial missing of an image at the center of the line image) and others.

To promote the toner image transfer, a technique is disclosed by application of the ultrasonic wave in the similar manner as the aforementioned technique (e.g. Japanese Laid-Open Patent Publication No. H4-234076). This is intended to improve the image transfer by solving the problem of instability when the toner image is transferred by corona charging while not in contact with the transfer destination body.

In the meantime, a contact transfer structure has come into general use, wherein a static electric field is applied to the transfer destination body while pressure is applied thereto, using a transfer member such as a transfer roller. Since toner is pressed against the photoreceptor at the place of contact. The toner tends to stick to the photoreceptor and to remain there without being removed. This will result in degenerated transfer efficiency.

In addition to the image forming apparatus based on the aforementioned contact transfer structure, an image forming apparatus wherein transfer operation is performed twice requires a further improvement of the transfer efficiency. To enhance transfer efficiency, a mechanical vibration device such as a device using the ultrasonic wave is employed as an auxiliary means, in addition to the conventional electrostatic transfer device.

A technique has been disclosed, for example, in Japanese Laid-Open Patent Publication No. H10-186896 wherein vibration by ultrasonic wave is applied directly to the transfer roller as a transfer member in the direction where the transfer destination body is conveyed, whereby transfer of the toner image onto the transfer destination body is assisted.

However, successful use of the vibration energy to improve transfer efficiency requires stable control of the vibration in the face of the mechanical instability of the transfer section. Thus, a necessary and sufficient amount of vibration must be provided.

For successful use of the vibration energy to improve transfer efficiency, the problem is that it is necessary to pay attention to the mechanical characteristics of the members constituting the transfer section, and to apply the mechanical vibration conforming to the natural frequency, so as to provide an efficient and stable vibration for improvement of the transfer efficiency However, even if this problem has been solved, there will be a substantial reduction in amplitude when the vibration has exhibited a slight deviation from the natural frequency. This will result in a failure to supply a sufficient amount of vibration.

In actual practice, vibration is affected by the fluctuation of the natural frequency per se of the members constituting the transfer section such as an image carrier and intermediate transfer member, the assembled status of these members, the degree of contact between a vibrator and these members, the degree of degeneration of these members, ambient temperature and humidity, and other factors. Accordingly, even if the vibration is controlled with reference to natural frequency, it is adversely affected by inevitable fluctuations. Thus, a sufficient vibration cannot be provided, and hence sufficient enhancement of transfer performance cannot be achieved in the conventional art.

### SUMMARY

An object of the present invention is to solve the aforementioned problems and to provide an image forming apparatus capable of improving and maintaining the transfer efficiency.

In view of forgoing, one embodiment according to one aspect of the present invention is an image forming apparatus, comprising:

a transfer source member which carries a toner image;

a transfer destination body which receives the toner image transferred from the transfer source member;

a vibration application section which applies vibration to at least one of the transfer source member and the transfer destination body; and

a vibration control section which controls the vibration applied by the vibration application section to cyclically vary a frequency of the vibration applied to the transfer source member or the transfer destination body by the vibration application section while the toner is being transferred from the transfer source member to the transfer destination body.

According to another aspect of the present invention, another embodiment is an image forming apparatus, comprising:

an transfer source member which carries a toner image;

a transfer destination body which receives the toner image transferred from the transfer source member;

a transfer member which contacts at least one of the transfer source member and the transfer destination body while the transfer;

a vibration application section which applies a vibration to the transfer member; and

a vibration control section which controls the vibration applied by the vibration application section to cyclically vary a frequency of the vibration applied to the transfer member by the vibration application section while the toner is being transferred from the transfer source member to the transfer destination body.

### BRIEF DESCRIPTION OF THE DRAWINGS

FIG. 1 is a drawing representing an example of the overall configuration of the image forming apparatus as an embodiment of the present invention;

FIG. 2 is a drawing representing an example of the configuration of the image forming apparatus as an embodiment of the present invention, when vibration is applied to the primary transfer section of the image forming apparatus;

FIG. 3 is a drawing showing the force applied to the toner at the time of transfer;

FIG. 4 is a diagram showing an example of the relationship between the frequency of the vibration applied to the transfer source member or transfer destination body and the amplitude of the actual vibration;

FIG. 5 is a diagram using a histogram to show the variations in natural frequency of the transfer section according to the member lot;

FIG. 6 is a diagram showing an example of the configuration of the image forming apparatus of the present embodiment when vibration is applied to the secondary transfer section of the image forming apparatus;

FIG. 7 is a flow chart showing an example of controlling the procedure of applying vibration to the transfer section;

FIG. 8 is a diagram showing an example of the sequence of the vibration control procedures along the time axis; and

FIG. 9 is a diagram showing another example of the sequence of the vibration control procedures along the time axis.

### DETAILED DESCRIPTION OF THE PREFERRED EMBODIMENT

The following describes an embodiment of the image forming apparatus according to the present invention with reference to drawings:

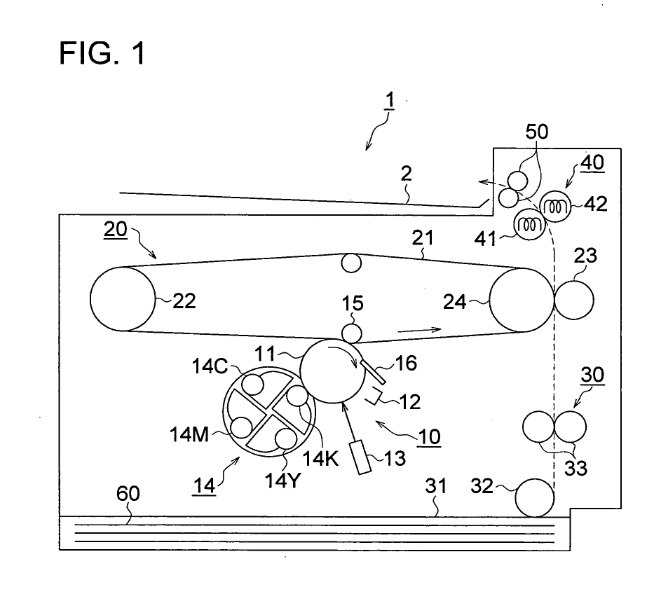

(Overall Configuration of the Image Forming Apparatus) FIG. 1 is a drawing representing an example of the overall configuration of the image forming apparatus as the present embodiment. FIG. 1 shows the overall configuration of the image forming apparatus, using an example wherein an single photoreceptor is used to carry out 4-cycle color development and the images are sequentially transferred onto the intermediate transfer belt one on top of another. After that, the images are transferred from the intermediate transfer belt to the recording medium.

As shown in FIG. 1, the image forming apparatus 1 is provided with an image forming section 10, intermediate transfer section 20, sheet feed section 30 and fixing section 40.

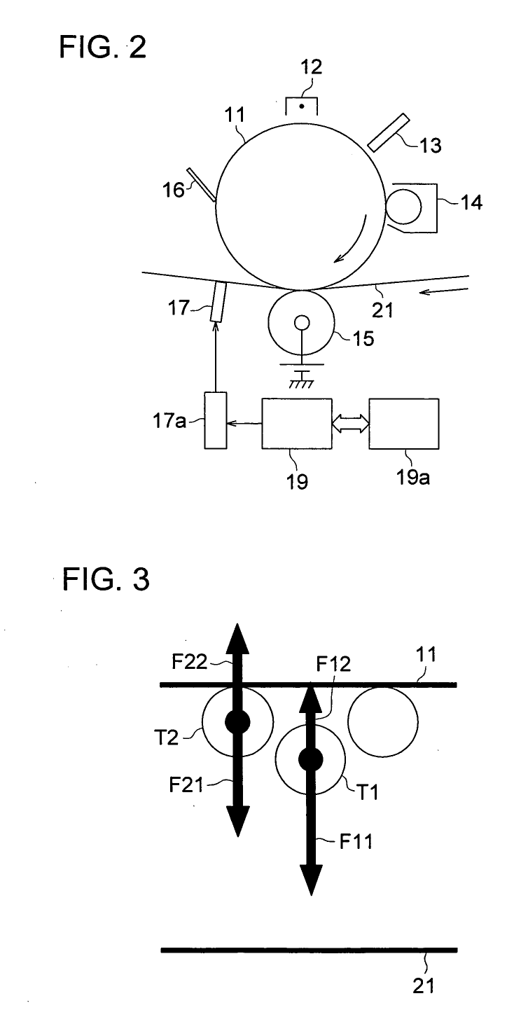

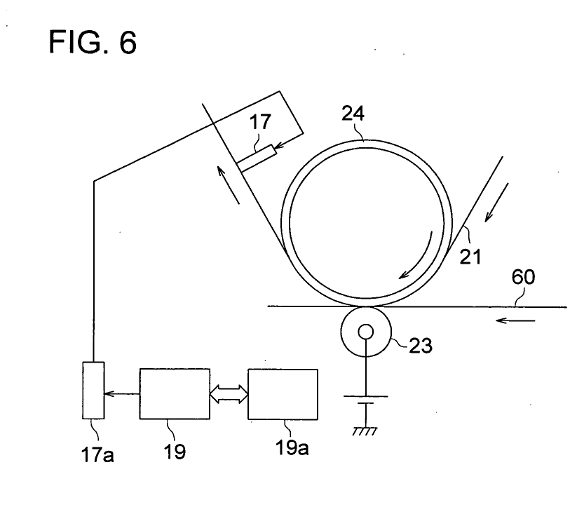

The vibration apparatus as a vibration application device in the present embodiment is shown in FIG. 2 representing the details of the primary transfer section (to be described later) or in FIG. 6 representing the details of the secondary transfer section. The advantages of the operation of the vibration application device will be described with reference to FIG. 2 (to be described later). It will not be described with reference to FIG. 1 representing the overall configuration.

In FIG. 1, the image forming section 10 is provided with a photoreceptor drum 11 as an example of the photoreceptor, a charging device 12, an exposure unit 13, a developing apparatus 14 containing the developing devices 14C, 14M, 14Y and 14K corresponding to the colors of cyan (C), magenta (M), yellow (Y) and black (K) respectively, a cleaner 16 and a primary transfer roller 15.

The photoreceptor drum 11 is designed in a cylindrical shape, and a photoreceptor layer (not illustrated) is formed on the surface of this drum. The drum rotates in the clockwise direction as shown in FIG. 1. A charging device 12, exposure unit 13, developing apparatus 14, and primary transfer roller 15 are arranged on the outer periphery of the photoreceptor drum 11 in the rotating direction of the aforementioned photoreceptor drum 11.

The charging device 12 charges the surface of the photoreceptor drum 11 up to a predetermined potential.

The exposure unit 13 applies light to the surface of the photoreceptor drum 11 and reduces the charged level inside the illuminated area, whereby an electrostatic latent image is formed.

The developing apparatus 14 rotates so that the developing devices 14C, 14M, 14Y and 14K sequentially faces the photoreceptor drum 11, and develops each of the latent color images formed for each color on the photoreceptor drum 11. To be more specific, toner is carried to the development area of the photoreceptor drum 11 for each color, so that the toner is supplied to the electrostatic latent image on the surface of the photoreceptor drum 11, whereby a toner image is formed.

The primary transfer roller 15 is arranged face to face with the photoreceptor drum 11, with the intermediate transfer belt 21 located in-between, and rotates in contact with the aforementioned photoreceptor drum 11 through the aforementioned intermediate transfer belt 21. On the nip portions of the primary transfer roller 15 and photoreceptor drum 11, primary transfer is carried out from the photoreceptor drum 11 to the intermediate transfer belt 21.

The primary transfer roller 15 and photoreceptor drum 11 are kept in contact across the entire width of the nip through the intermediate transfer belt 21.

In the primary transfer process, a transfer bias voltage having a polarity opposite to that of the toner is applied to the primary transfer roller 15 from the power supply (not illustrated). This arrangement allows an electric field to be formed between the aforementioned primary transfer roller 15 and photoreceptor drum 11 at the primary transfer position. Each of the color toner images on the photoreceptor drum 11 is electrostatically adsorbed by the intermediate transfer belt 21, and is transferred onto the aforementioned intermediate transfer belt 21.

When a toner image has been transferred onto the intermediate transfer belt 21 for each color, the cleaner 16 removes the remaining toner from the photoreceptor 11. This is followed by formation of the image of the next color.

The aforementioned process is repeated for each color, and the developing apparatus 14 rotates every time. Each of the color toner image having been developed by the developing devices 14C, 14M, 14Y and 14K is primarily transferred onto the intermediate transfer belt 21 at correctly adjusted positions, and a four-color superimposed toner image is formed. This step is followed by the next secondary transfer.

The intermediate transfer section 20 is equipped with an intermediate transfer belt 21 as an intermediate transfer member, drive roller 22, a secondary transfer roller 23 as a transfer member, and a backup roller 24 also as a transfer member.

The intermediate transfer belt 21 is an endless belt applied between the drive roller 22 and backup roller 24, and is turned in the counterclockwise direction as shown in FIG. 1 when the aforementioned drive roller 22 is driven.

The secondary transfer roller 23 and backup roller 24 are arranged face to each with each other, wherein the intermediate transfer belt 21 is located in-between. These rollers are rotated through the aforementioned intermediate transfer belt 21. On the nip portions of the secondary transfer roller 23 and backup roller 24, secondary transfer is carried out from the intermediate transfer belt 21 to the recording medium 60.

In the secondary transfer process, a transfer bias voltage having a polarity opposite to that of the toner is applied to the secondary transfer roller 23 from the power supply (not illustrated). This arrangement allows an electric field to be formed between the secondary transfer roller 23 and backup roller 24. The toner image on the aforementioned intermediate transfer belt 21 is electrostatically adsorbed by the recording medium 60 passing through between the aforementioned secondary transfer roller 23 and intermediate transfer belt 21, and is transferred onto the aforementioned the recording medium 60.

The sheet feed section 30 is provided with a sheet feed cassette 31 for storing the recording medium 60, a pickup roller 32 for feeding the aforementioned recording medium 60 from the aforementioned sheet feed cassette 31, and a pair of registration rollers 33 for sending the recording medium 60 having been fed, to the secondary transfer position. The recording medium 60 is fed to the secondary transfer position properly timed with the secondary transfer.

The fixing section 40 is provided with a pair of fixing rollers 41 and 42 which are arranged face to face with each other to rotate in contact with each other. Each of the fixing rollers 41 and 42 is provided with a heater. When the recording medium 60 passes between the aforementioned fixing rollers 40, pressure is applied to the recording medium 60 under a high temperature. Thus, the toner forming a toner image on the recording medium 60 is fused and fixed on the aforementioned recording medium 60. After fixing is over, the recording medium 60 is ejected onto the sheet ejection tray 2 by a sheet ejection roller 50.

(An Example of the Configuration of the Primary Transfer Section in the Image Forming Apparatus)

FIG. 2 shows an example of the configuration of the primary transfer section when vibration is applied to the primary transfer section of the image forming apparatus in the present embodiment. The arrangement in FIG. 2 is upside down as compared to that of FIG. 1, but they are equivalent to each other. With reference to FIG. 2, the following describes the details of the primary transfer wherein toner image is transferred from the photoreceptor drum 11 as an image carrier to the intermediate transfer belt 21 as an intermediate transfer member. In this example of primary transfer, the image carrier serves as a transfer source member, and the intermediate transfer member as a transfer destination body.

As shown in FIG. 2, on the outer periphery of the photoreceptor drum 11, a charging device 12, exposure unit 13, developing apparatus 14, and primary transfer roller 15 as a transfer member are arranged along the rotating direction of the aforementioned photoreceptor drum 11.

The developing apparatus is schematically illustrated. In actual practice, this apparatus is equipped with four-color developing devices, as shown in FIG. 1. In this example, developing devices of a plurality of colors are given, but the developing apparatus can be equipped with only one developing device. It is also possible to use a so-called tandem type, wherein the image forming sections illustrated in FIG. 2 are provided for four colors. The following description is also applicable to the configuration of the primary transfer portion and the operation thereof.

In FIG. 2, the reference numeral 17 denotes a vibrator for applying vibration to the intermediate transfer belt 21, the 17a indicates a drive section for driving the vibrator. The vibrator 17 and the drive section 17a constitute a vibration apparatus as a vibration application device. The radio frequency denotes a vibration control section made up of a CPU, and the 19a is a memory exemplified by a RAM. The vibration control section 19 and memory 19a collaborate with each other to serve as a vibration control section. Other reference numerals are the same as those of FIG. 1.

The following describes the arrangement of the vibration application device: The vibrator 17 is arranged to directly contact the surface on the side where the toner of the intermediate transfer belt 21 is not transferred. With consideration given to the possible deflection of the intermediate transfer belt 21, the vibrator 17 is pressed against the intermediate transfer belt 21 under pressure adequate to transmit vibration.

It goes without saying that the vibrator 17 can be pressed against the photoreceptor drum 11 or the primary transfer roller 15 as a transfer member. When it is pressed against the intermediate transfer belt 21, vibration is applied directly to the downstream side of transfer nip where the vibration can more contribute to transfer efficiency.

The site pressed against the vibrator 17 is not the transfer nip position of the intermediate transfer belt 21, but the position on the downstream side of the transfer nip position in the rotating direction of the intermediate transfer belt 21. In this example, if the primary transfer roller 15 is arranged at the transfer nip position, a greater contribution is made to improving the transfer rate on the downstream side rather than on the upstream side.

The vibrator 17 is an ultrasonic vibrator capable of providing vibration in the frequency in the ultrasonic range (20 through 40 kHz), as exemplified by a piezoelectric device. Vibration is caused in response to the drive voltage and frequency outputted from the drive section 17a. The drive section 17a is a power supply for outputting the drive voltage to the vibrator 17. Controlled by the vibration control section 19, it changes the frequency according to the instruction of the control section 19, and outputs the designated drive voltage.

For example, when sine-wave output voltage V (t)=V0 sin (2 πft) with amplitude V0 and oscillation frequency f has been outputted from the drive section 17a, a temporal displacement expressed by X (t)=X0 sin (2 πft), i.e. sine-wave vibration occurs to the vibrator 17, accordingly. This vibration is transmitted to the transfer nip section through the intermediate transfer belt 21, and a slight vibration occurs at the transfer nip section.

The vibration control section 19 is used to control the vibration provided by the vibration application device, and designates the start of vibration properly timed with image formation. Further, the vibration frequency of the drive voltage and the magnitude of the output are set in conformity to the sequence of image formation, and this instruction is sent to the drive section 17a.

Further, the vibration control section 19 reads out the required information from the memory 19a whenever required, including the information on the vibration frequency of the drive voltage and the magnitude of the output to be set for the drive section 17a.

Before describing the aforementioned vibration application control procedure, the following describes the conventional transfer mechanism, and the vibration application procedure as an improvement of the conventional mechanism.

(Improved Transferability by Application of Mechanical Vibration)

The following describes the usual process wherein the toner image on the photoreceptor drum 11 is transferred onto the intermediate transfer belt 21: The primary transfer roller 15 is arranged face to face with the photoreceptor drum 11 through the intermediate transfer belt 21, whereby a transfer nip portion. When a bias voltage is applied to the primary transfer roller 15, transfer electric field is applied to the transfer nip portion. This electric field ensures that the toner charged on the photoreceptor drum 11 receives electrostatic power, and is electrostatically adsorbed by the intermediate transfer belt 21.

Referring to FIG. 3, the following describes the force working on toner. FIG. 3 schematically shows the toner position at the nip portions between the photoreceptor drum 11 and intermediate transfer belt 21 and the force working thereon. The illustrated toner is only a representative example. In actual practice, a great many toner particles normally form a layer.

The reference numerals T1 and T2 denote the toner to be transferred, and the F11 and F21 indicate the transfer force to the intermediate transfer belt 21 working on the T1 and T2, respectively. The F12 and F22 adhesion force to the photoreceptor drum 11 working on the T1 and T2, respectively.

The transfer force (F=qE, where q denotes the amount of electrical charge, and E the electric field working on the toner) is smaller as it is closer to the photoreceptor drum 11 and is greater as it is closer to the intermediate transfer belt 21 (i.e. F11>F21), due to the difference in strength of the electric field resulting from space charge. Conversely, adhesion force depends on the distance from the photoreceptor drum 11; it is greater as it is closer to the photoreceptor drum 11, and is smaller as it is closer to the intermediate transfer belt 21 (i.e. F12<F22).

Such being the case, the toner T1 can be transferred more easily than the toner T2. To be more specific, toner is transferred more easily as it is closer to the intermediate transfer belt 12.

The transfer efficiency of toner is preferably 100%. Efforts have been made to improve the transfer efficiency by devising the method of applying the transfer bias, by adjusting the transfer conditions such as transfer roller materials or by improving toner performances. In actual practice, toner remains on the photoreceptor drum 11 in the amount equivalent to several percent through several dozen percent. Accordingly, the actual machine requires use of a cleaner 16 and others.

Whether toner is transferred or not is determined by the magnitude of the aforementioned transfer force and adhesion force. Based on this principle, measures have been taken to increase the transfer force or to decrease the adhesion force. If the electric field is increased in order to increase the transfer force, electric discharge may occur. If the amount of electrostatic charge of toner is decreased in order to decrease the adhesion force, transfer force will also be reduced.

In the embodiment of the present invention, mechanical vibration is used to reduce the adhesion force, mechanical vibration is applied to the photoreceptor drum 11 or intermediate transfer belt 21. Then this vibration energy applies vibration to the toner at the transfer nip portion. Namely, perturbation is applied to the distance of adhesion between toner and the photoreceptor drum, whereby a moment when adhesion is reduced is created.

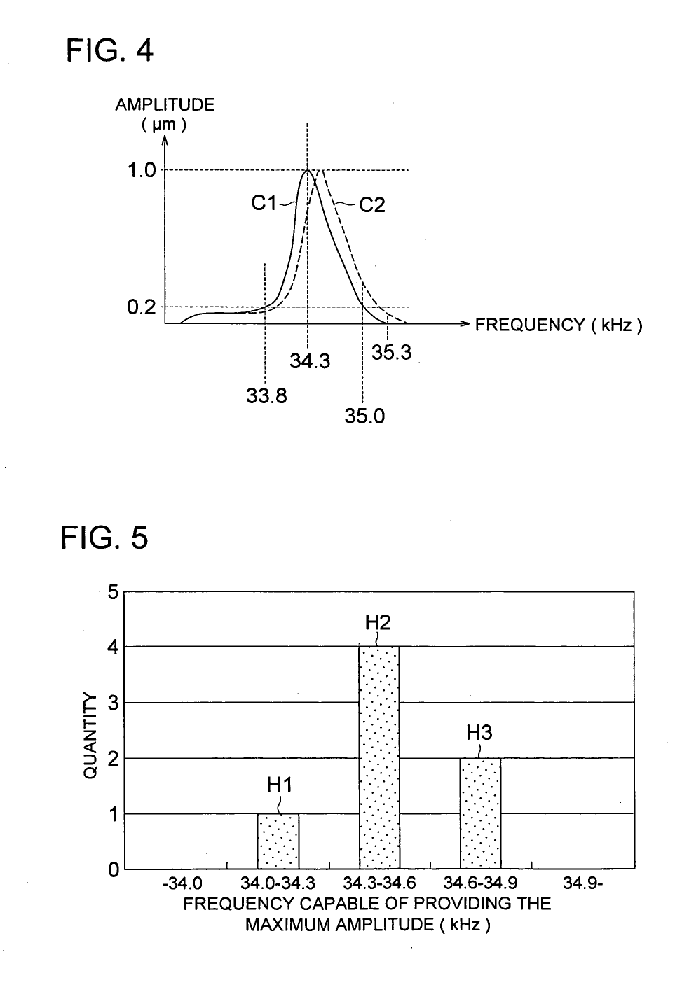

Referring to FIG. 4, the following describes the method of applying vibration energy using the natural frequency and the effect on transfer performances. FIG. 4 illustrates the relationship between the frequency of the vibration having been applied to the transfer source member or transfer destination body to which vibration is applied, and the amplitude of the actual vibration.

The present example takes up the intermediate transfer belt 21 as an intermediate transfer member. When a specific vibration frequency (34.3 kHz) is given to the intermediate transfer belt, the amplitude of the vibration has a peak value (illustrated by the curve C1). Vibration frequency wherein this amplitude becomes the maximum is the natural frequency. The effect of improving the transfer rate increases with the amplitude. Accordingly, it is effective to apply vibration so as to get a natural frequency.

However, as can be seen from FIG. 4, a slight departure from the natural frequency causes an abrupt decline of amplitude. This requires severe frequency control to be provided. Despite the severest control of vibration frequency, natural frequency per se is subjected to fluctuation in some cases due to variations of the material, arrangement and assembling of the members, the degree of contact, deterioration in durability and environmental changes. Thus, the maximum amplitude of vibration is difficult to maintain.

FIG. 4 shows the characteristics when the original natural frequency of 34.3 kHz has fluctuated to 34.5 kHz (illustrated by curve C2). A slightest deviation in frequency results in a substantial reduction of amplitude.

FIG. 5 uses a histogram to show the result of checking the variations by measuring the natural frequency of the intermediate transfer belts of the same production lot. For this measurement, a non-contact displacement detector such as a laser displacement meter was arranged face to face with the intermediate transfer belt so that they would not contact each other. The aforementioned vibration application device was used to vibrate the intermediate transfer belt, thereby finding the vibration frequency where the output amplitude measured by the displacement meter has a peak value.

In FIG. 5, seven samples were used. There was one item of data in the range H1 wherein the natural frequency—the vibration frequency at which the maximum amplitude was obtained—is from 34.0 through 34.3 kHz. There were four items of data in the range H2 wherein the natural frequency is from 34.3 through 34.6 kHz. There were two items of data in the range H3 wherein the natural frequency is from 34.6 through 34.9 kHz.

As will be apparent from this histogram, there are substantially large variations in natural frequency of the intermediate transfer belts in production lots. Each vibration condition may have to be adjusted separately, depending on the case.

In the present embodiment, to solve the aforementioned problems, vibration control is provided in such a way that the natural frequency is always contained in the frequency of the vibration applied while toner passes through the transfer nip portion, despite the fluctuation in natural frequency, as will be described more specifically later.

(Example of the Configuration of the Secondary Transfer Section in the Image Forming Apparatus)

FIG. 6 shows the configuration when vibration is applied to the secondary transfer section in the image forming apparatus of the present invention. Referring to FIG. 6, the following describes the details of the secondary transfer wherein the toner image is transferred to the recording medium 60 from the intermediate transfer belt 21 as an intermediate transfer member: In this example of the secondary transfer, the intermediate transfer member serves as a transfer source member, and the recording medium is used as a transfer destination body.

As shown in FIG. 6, the intermediate transfer belt 21 and the recording medium 60 are sandwiched, so as to be in contact with each other, by the secondary transfer roller 23 and backup roller 24 as the transfer members arranged face to face with each other, and form a transfer nip portion of the secondary transfer.

In FIG. 6, similarly to the case of primary transfer illustrated in FIG. 2, the reference numeral 17 is a vibrator for applying vibration to the intermediate transfer belt 21. The reference numeral 17a is a drive section for driving this vibrator. The vibrator 17 and the drive section 17a constitute the vibration apparatus as a vibration application device. The reference numeral 19 denotes a vibration control section made up of a CPU, and 19a is a memory such as a RAM. The vibration control section 19 and memory 19a collaborates with each other to serve as a vibration control section. Other reference numerals are the same as those of FIG. 1.

The following describes the arrangement of the vibration application device. The vibrator 17 is arranged in direct contact with the surface on the side of the intermediate transfer belt 21 where a toner image is not formed. The vibrator 17 is pressed against the intermediate transfer belt 21 under adequate pressure for transmission of vibration, with due consideration given to the possible deflection of the intermediate transfer belt 21.

It goes without saying that the vibrator 17 can be pressed against the recording medium 60 or the secondary transfer roller 23 as a transfer member.

Pressure is applied to the vibrator 17 at downstream of the transfer nip in the rotating direction of the intermediate transfer belt 21, not at the transfer nip position of the intermediate transfer belt 21. This is because more contribution is made to the improvement of transfer rate downstream rather than upstream.

The configuration of the vibrator 17, the drive section 17a, vibration control section 19 and memory 19a is different from the arrangement where vibration is applied to the primary transfer section as described above. The vibration frequency is set to the range conforming to the member to be vibrated. However, their functions and operations are the same as those described with reference to the configuration of the primary transfer.

The following describes the normal process where the toner image on the intermediate transfer belt 21 is transferred to the recording medium 60: The secondary transfer roller 23 is arranged face to face with the intermediate transfer belt 21 through the recording medium 60 to form a transfer nip portion. When a bias voltage is applied to the secondary transfer roller 23, a transfer electric field is applied to the transfer nip portion. This electric field causes electrostatic power to be applied to the toner charged on the intermediate transfer belt 21, and the toner is electrostatically adsorbed by the recording medium 60.

The aforementioned transfer process is the same as the primary transfer process. The position of the toner at the nip portions between the intermediate transfer belt 21 and the recording medium 60 and the force working thereon are also the same as those in the case of the primary transfer described with reference to FIG. 3, except that the photoreceptor drum 11 of FIG. 3 is replaced by the intermediate transfer belt 21, and the intermediate transfer belt 21 of FIG. 3 is replaced by the recording medium 60.

Further, the aforementioned transfer process is the same as the primary transfer process in the following points: A mechanical vibration of higher amplitude is used in order to improve transfer rate by reducing the adhesion force. Vibration is placed under control at the natural frequency as a result, but the fluctuation of natural frequency is unavoidable. To cope with this situation, vibration control is provided so that natural frequency is always included while toner passes through the transfer nip portion, despite possible fluctuation of natural frequency.

(Vibration Application Control Procedure)

Application of vibration in the primary transfer section configured as illustrated in FIG. 2 for the primary transfer from the aforementioned photoreceptor drum 11 to the intermediate transfer belt 21 is the same in the procedure of vibration application control as the application of vibration in the secondary transfer section according to the aforementioned configuration of FIG. 6 for the secondary transfer from the intermediate transfer belt 21 to the recording medium 60.

Both the control procedures in the processing example 1 and processing example 2 to be described below can be used in the application of vibration in the primary transfer section and application of vibration in the secondary transfer section. Further, even when the transfer source member serves as a photoreceptor, and the transfer destination body is used as a recording medium, the same control procedure can be used based on the adequate vibrator configuration.

### PROCESSING EXAMPLE 1

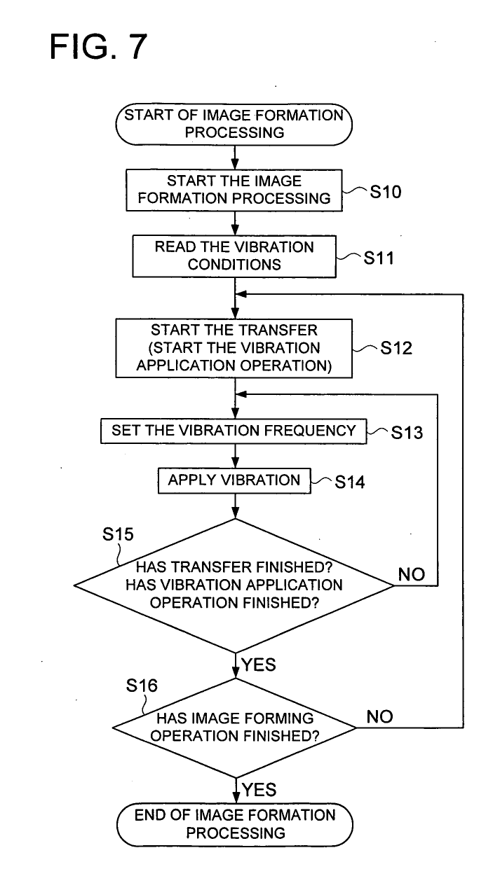

Referring to FIG. 7, the following describes the vibration application control in the primary or secondary transfer section: FIG. 7 is a flow chart showing the flow of the vibration application procedure. The following description conforms to the flow of FIG. 7, with occasional reference to FIG. 2 as required.

In FIG. 7, image formation processing starts in the Step S10. Then in the Step S11, the vibration control section 19 reads the vibration conditions stored in the memory 19a. The vibration conditions refer to the conditions to be instructed to the drive section 17a in order to vibrate the vibrator 17, and are made up of the drive voltage V signifying the magnitude of vibration and the change conditions of the vibration frequency f (to be described later).

When the transfer operation has started in the Step S12, the vibration application procedure starts. The vibration control section 19 sends information on the vibration frequency f and the initial value of the drive voltage V to the drive section 17a according to the vibration conditions read out from the memory 19a. According to this instruction, the drive section 17a gives vibration to the vibrator 17.

The procedures in the Step S13 through Step S15 are repeated during the transfer. Until the transfer is finished, vibration control is carried out to apply vibration by changing the vibration frequency according to the conditions.

In the Step S13, the frequency f of the vibration to be applied is set. The range for changing the frequency f in advance by allowing for the possible fluctuation of natural frequency and the method of change are stored in the memory 19a. The vibration control section 19 sets the vibration frequency f according to the vibration conditions read out. At this time, the output V of the drive voltage V sin (2 πf) corresponding to the vibration frequency f has been read out from the memory 19a and is set to an adequate predetermined value.

In the Step S14, vibration is applied. The vibration control section 19 instructs the drive section 17a to apply the vibration of the frequency f and voltage V having been set in the Step S13. The drive section 17a causes the vibrator 17 to be vibrated according to the vibration frequency f and voltage V provided by the vibration control section 19.

In the Step S15, a decision step is taken in the vibration control section 19 to check if the transfer operation has completed or not, namely, if application of vibration should be continued or not.

If the transfer operation has completed (Step S15: YES), the vibration control section 19 causes the drive section 17a to complete vibration and executes the processing in the Step S16. When transfer has not yet completed (Step S15: NO), the system goes back to the Step S13 without suspending application of the vibration. A new vibration frequency f is set in the Step S13 for the purpose of changing the vibration frequency f according to the vibration conditions. Processing from the Step S13 to Step S15 is repeated until transfer operation completes.

In the Step S16, a decision step is taken to determine whether all image forming operations have completed or not. If the image forming operation has completed (Step S16: YES), the processing of vibration control also completes. If the image forming operation has not yet completed (Step S16: NO), the system goes back to the Step S12, and processing from the Step S12 to Step S16 is repeated until all the image forming operations completes.

As described above, the operation of processing example 1 is performed in two phases; setting of the vibration conditions at the time of starting the image forming operation and application of vibration at the time of image formation. In the phase of setting the vibration conditions at the time of starting the image forming operation, conditions for changing the vibration frequency f during transfer operation are set. In the phase of applying vibration at the time of image formation, vibration control is provided in such a way that the vibration is applied by actually changing the vibration frequency under the preset change conditions.

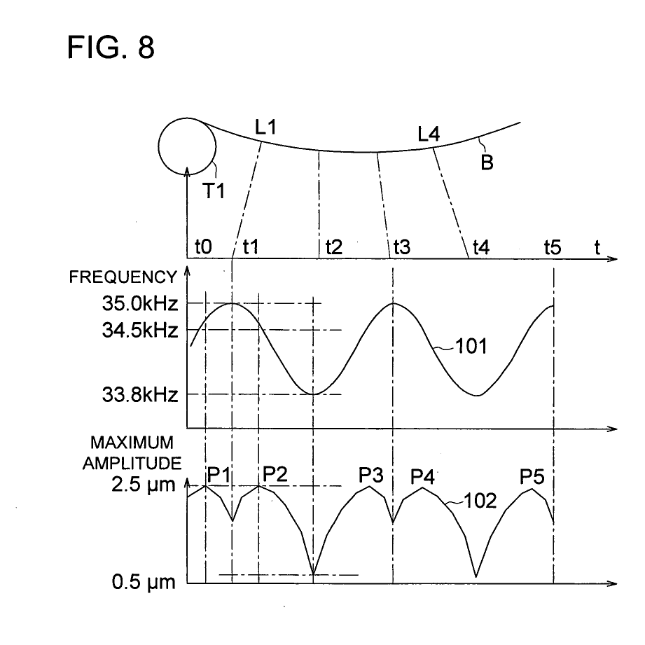

Referring to FIG. 8, the following describes the processing in the aforementioned phases: FIG. 8 shows the sequence of the operation along the time axis. FIG. 8 shows a change in vibration status in one transfer operation for the period from the toner being fed into the transfer nip portion and transferred to the toner being fed out.

When the process of image formation has started, the main motor starts operation. Application of vibration starts at time t0.

Toner T1 carried on the transfer source member B reaches the position L1 on the transfer source member B at time t1. The transfer nip portion ranges from the position L1 position to L4 on the transfer source member B. The toner T1 enters the transfer nip portion at time t1. The frequency of the vibration applied during this time changes as shown in the curve 101. This means that the instruction of vibration frequency f issued from the vibration control section 19 to the drive section 17a changes according to the vibration conditions as shown by the curve.

During the time period from time t1 to time t4 through t2 and t3, the toner T1 moves from the position L1 to L4 on the transfer source member B. During this time, application of vibration continues. The vibration frequency changes along the sine curve as shown by the frequency change curve 101.

In response to the change in vibration frequency, the vibration amplitude also exhibits a change as shown by the amplitude change curve 102. In this case, however, the form of the amplitude change curve 102 is different from that of the frequency change curve 101. This is due to the characteristic that amplitude has a peak during the vibration at the natural frequency. The positions P1 through P5 on the axis of time t where the amplitude change curve 102 has the maximum value (peak) conforms approximately to the position on the axis of time t where the frequency change curve 101 has a value of 34.5 kHz. This means that the natural frequency is 34.5 kHz.

At the time t4, the toner T1 reaches the position L4 on the transfer source member B, and is making an attempt to get out of the transfer nip portion. Even when the toner T1 has got out of the transfer nip portion thereafter, there still remains the toner being transferred. When the entire toner to be transferred has got out of the transfer nip portion, namely, when transfer has completed, application of vibration stops at the time t5.

Such being the case, application of vibration continues from time t0 to t5. However, for toner T1, for example, the toner to be transferred is now passing through the transfer nip portion, and application of vibration to encourage transfer is valid for the time period for the passage through the transfer nip portion from time t1 to t4. The frequency change curve 101 from time t1 to t4 indicates that the frequency change covers approximately one and a half cycle. During this time period, the vibration frequency agrees with the natural frequency of 34.5 kHz three times. This corresponds to the peak positions P2, P3 and P4 of the amplitude change curve 102. To be more specific, the toner T1 is subjected to vibration of the maximum amplitude three times during transfer operation.

If the maximum amplitude can be obtained at least one pulse during the passage through the transfer nip, the toner will be subjected to the improved transfer force corresponding to the vibration obtained at that amplitude. As will be described later, the result is not inferior to the case where the vibration frequency capable of obtaining the same amplitude is maintained during the passage through the transfer nip portion.

Accordingly, in this case, if there is a slight deviation in natural frequency from 34.5 kHz, only slight deviations of the peak positions P2, P3 and P4 will occur in the amplitude change curve 102. Toner will be subjected to the vibration at the maximum amplitude approximately three times during the period of transfer. In other words, this vibration enhances the transfer performance.

A change in vibration frequency expressed by the frequency change curve 101 is meaningful when vibration frequency is changed close to the natural frequency. It can be changed in many ways. The following processing example 2 shows the case of a simple linear change.

### PROCESSING EXAMPLE 2

The following describes another example of vibration application control in the primary transfer section. In this case, only the vibration conditions differ. The flow chart of FIG. 7 shown with reference to the processing example 1 is applicable to the flow of vibration application operation control. To avoid duplication, the flow of vibration application operation control will not be described.

Similarly to the case of the processing example 1, setting of the vibration condition at the time of starting the image forming operation is setting of the condition for changing the vibration frequency f during transfer. Vibration control is provided during image formation in such a way as to apply vibration while actually changing the vibration frequency under the preset change condition. This change condition is the only difference from processing example 1.

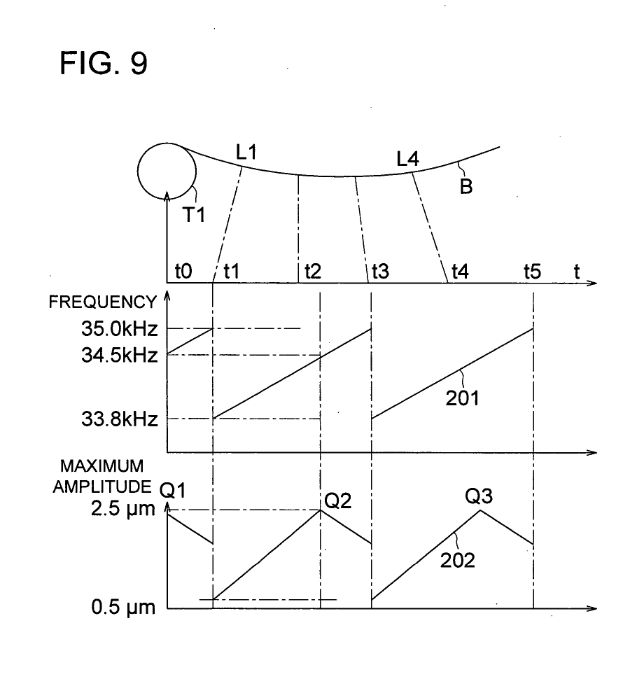

Referring to FIG. 9, the following describes these phases of processing. FIG. 9 shows the operation sequence along the time axis. Similarly to the case of FIG. 8, FIG. 9 shows a change in vibration status in one transfer operation, where the toner to be transferred is fed into the transfer nip portion, is transferred, and is fed out. The same reference numerals as those of FIG. 8 are used for the same time and same position.

When the image formation processing has started, the main motor starts operation. Application of vibration starts at time t0.

Toner T1 carried on the transfer source member B reaches the position L1 on the transfer source member B at time t1, and enters the transfer nip portion. During the time period from time t1 to time t4 through t2 and t3, the toner T1 moves from the position L1 to L4 on the transfer source member B. During this time, application of vibration continues. The vibration frequency changes along the sine curve as shown by the frequency change curve 101. At time t4, the toner T1 reaches the position L4 position on the transfer source member B, and is making an attempt to get out of the transfer nip portion.

Even when the toner T1 has got out of the transfer nip portion thereafter, there still remains the toner being transferred. When the entire toner to be transferred has got out of the transfer nip portion, namely, when transfer has completed, application of vibration stops at the time t5. The aforementioned procedure is the same as that in the processing example 1.

The frequency of the vibration applied during this time changes according to a discontinuous (or zigzag) straight line 201, as shown in FIG. 9. This means that the instruction of vibration frequency f issued from the vibration control section 19 to the drive section 17a changes according to the vibration conditions as illustrated. Unlike the cases in the processing example 1, the frequency change curve 201 exhibits a linear change from the minimum frequency to the maximum frequency.

In response to the change in vibration frequency, the vibration amplitude also exhibits a change as shown by the amplitude change curve 202. For the same reason that the amplitude has a peak during the vibration at the natural frequency, the shape of the amplitude change curve 202 is different from that of the frequency change curve 201. The positions Q1 through Q3 on the axis of time t where the amplitude change curve 202 has the maximum value (peak) conforms to the position on the axis of time t where frequency change curve 201 has a value of 34.5 kHz. This is also the same as the case in processing example 1.

The frequency change curve 201 from time t1 to t4 for the toner T1 to pass through the transfer nip portion indicates that that the frequency change covers approximately one and a half cycle, as in the case of the processing example 1. During this time period, the vibration frequency agrees with the natural frequency of 34.5 kHz only once in the present case. This corresponds to the peak position Q2 of the amplitude change curve 202. To be more specific, the toner T1 is subjected to vibration of the maximum amplitude once during transfer operation, namely, at the peak position Q2 of the amplitude change curve 202.

If the maximum amplitude can be obtained at least one pulse during the passage through the transfer nip, the toner will be subjected to the improved transfer performance corresponding to the vibration obtained at that amplitude. Thus, the same advantages as those of the processing example 1 can be obtained in the processing example 2.

In this case, if there is a slight deviation in natural frequency from 34.5 kHz, only a slight deviations of the peak position Q2 will occur in the amplitude change curve 202. Toner will be subjected to the vibration at the maximum amplitude once during the period of transfer. In other words, this vibration enhances the transfer performance.

### EXAMPLES

Based on the aforementioned forms of embodiment, the following describes the examples of the embodiments of the present invention.

The image forming apparatus that has been used is a 4-cycle color printer shown in FIG. 1. As shown in FIG. 6, vibration is applied to the intermediate transfer belt of the secondary transfer section by means of vibrators. Vibrators are arranged along the rotating direction of the intermediate transfer belt. They are contacted with pressure about 1 cm downstream of the transfer nip portion, with the tips oriented toward the transfer nip portion.

The tip of the vibrator is provided with a jig made of SUS material. A metal such as titanium or aluminum may be used as the material. The surface of the tip jig comes in contact with the intermediate transfer belt and rubs against it. To avoid abrasion, a gel layer having a thickness of 10 μm or less is provided so that the dynamic friction coefficient between the surfaces will not exceed 0.6.

The intermediate transfer belt is made of a high molecular material provided with carbon black, and the resistance across the width is about 10⁶ through 10¹⁵Ω. A commonly used PPC sheet is used as a recording medium. The sheet is conveyed at a speed of 300 mm/s.

Table 1 shows the results of evaluating the image subsequent to transfer using an example of embodying the present invention, an example of fixing the vibration frequency for the sake of comparison, and an example where vibration is not applied.

TABLE 1

| | | | Vibration | | |
|---|---|---|---|---|---|
| | Vibration | Natural | frequency | | Image |
| | control | frequency | change range | | evaluation |
| Example 1 | (Processing | 34.5 kHz | 33.8-35.0 | kHz | B |
| | example 1) | | | | |
| Example 2 | (Processing | 34.5 kHz | 33.8-35.0 | kHz | B |
| | example 2) | | | | |
| Example 3 | (Processing | 34.3 kHz | 33.8-35.0 | kHz | B |
| | example 1) | | | | |
| Example 4 | (Processing | 34.3 kHz | 33.8-35.0 | kHz | B |
| | example 2) | | | | |
| Comparative | Fixed | 34.3 kHz | 34.5 | kHz | D |

| | | | | |
|---|---|---|---|---|
| example 1 | vibration | | (fixed) | |
| | frequency | | | |
| Comparative | No vibration | 34.5 kHz | Nil | E |
| example 2 | | | | |

Intermediate transfer belts of different production lots are used in the examples 1 and 2 and the examples 3 and 4. This is intended to employ different natural frequencies. However, the same range is used for changing the vibration frequency. The range for changing the vibration frequency is determined by considering the variations in the histogram of FIG. 5.

There is a difference in the method of changing the vibration frequency between the examples 1 and 3, and the examples 2 and 4 (between the processing example 1 and processing example 2). In the Comparative Example 1, the frequency of the vibration to be applied is constant, whereas no vibration is given in the comparative example 2.

Except for the aforementioned conditions on vibration control, all the transfer conditions are the same. The transfer nip width is approximately 6 mm.

The image was evaluated according to the criteria shown in Table 2 by visual inspection of the sheet having been ejected after the image has been transferred and fixed thereon.

TABLE 2

| | Image (irregular transfer, | |
|---|---|---|
| Rank | skipping and dropout) | Transfer efficiency |
| B | No problem | Approx. 92% or more |
| D | Slight problem partly | Approx. 85 through 92% |
| E | Apparent problem partly | Less than approx. 85% |

The evaluation result of Table 1 demonstrates that an excellent transfer image is obtained in the embodiment of the present invention by getting a frequency pulse involving at least one maximum amplitude during the passage of the transferred toner through the transfer nip portion, independently of the method of changing the vibration frequency between the processing examples 1 and 2.

In the comparative example 1, the advantage is reduced by the frequency deviation of 0.2 kHz since the vibration frequency was not changed as in the processing example 1 or 2, although vibration at a fixed frequency was applied. In the comparative example 2, no vibration was given at all. The result of evaluation was the least satisfactory.

In the present embodiment, the range of vibration frequency change was from 33.8 through 35.0 kHz. It can be modified in response to the fluctuation of the natural frequency when the components have been assembled. It should be determined according to the tradeoffs between the vibrator performance and frequency variations range.

In the present embodiment of the present invention, if the natural frequency is changed due to some reason, the vibration frequency of at least one of the transfer source member and transfer destination body is also changed. This arrangement reduces the adverse effect of the fluctuation in the natural frequency. Typically, vibration control can be provided in such a way that the natural frequency is included while toner passes through the transfer nip portion. This always provides stable vibration at natural frequency, and hence achieves improvement and maintenance of the transfer efficiency by the stable transfer auxiliary device.

The aforementioned arrangement also solves the problems raised by variations and fluctuations in the natural frequency of the members resulting from different production lots. This eliminates the need of adjustment at the time of production and readjustment subsequent to shipment, thereby making a significant contribution to cost reduction.

As described above, the present embodiment of the present invention presents a solution of the problem that a sufficient vibration and sufficient transfer performance cannot be ensured due to various unavoidable factors, despite the vibration being controlled at the natural frequency. To solve such problems, the present embodiment provides an image forming apparatus wherein vibration control is provided to ensure sufficient vibration and to improve and maintain the transfer efficiency.

It is to be expressly understood, however, that the present invention is not restricted to the aforementioned embodiments. The present invention can be embodied in a great number of variations with appropriate modification or additions, without departing from the spirit and scope of the invention.

What is claimed is:

1. An image forming apparatus, comprising:
a transfer source member which carries a toner image;
a transfer destination body which receives the toner image transferred from the transfer source member;
a vibration application section which applies vibration to at least one of the transfer source member and the transfer destination body; and
a vibration control section which controls the vibration applied by the vibration application section to cyclically vary a frequency of the vibration applied to the transfer source member or the transfer destination body by the vibration application section while the toner is being transferred from the transfer source member to the transfer destination body.

2. The image forming apparatus of claim 1, wherein the vibration control section varies the frequency of the vibration applied to the transfer source member or the transfer destination body by the vibration application section in a predetermined range which includes a natural frequency of the transfer source member or transfer destination body to which the vibration is applied by the vibration application section.

3. The image forming apparatus of claim 1, wherein the vibration control section cyclically varies the frequency of the vibration applied by the vibration application section for no less than one cycle between predetermined upper and lower frequencies while the toner transferred from the transfer source member to the transfer destination body passes through a transfer nip portion where the transfer source member and the transfer destination body face each other.

4. The image forming apparatus of claim 1, wherein the vibration application section is positioned on the downstream side of the position where the toner image is transferred from the transfer source member to the transfer destination body.

5. The image forming apparatus of claim 1, wherein the frequency of the vibration is varied in sine curve fashion.

6. The image forming apparatus of claim 1, wherein the frequency of the vibration is varied linearly.

7. The image forming apparatus of claim 2, wherein the vibration control section cyclically varies the frequency of the vibration applied by the vibration application section for no less than one cycle between predetermined upper and lower frequencies while the toner transferred from the transfer source member to the transfer destination body passes through a transfer nip portion where the transfer source member and the transfer destination body face each other.

8. An image forming apparatus, comprising:
an transfer source member which carries a toner image;
a transfer destination body which receives the toner image transferred from the transfer source member;
a transfer member which contacts at least one of the transfer source member and the transfer destination body while the transfer;
a vibration application section which applies vibration to the transfer member; and
a vibration control section which controls the vibration applied by the vibration application section to cyclically vary a frequency of the vibration applied to the transfer member by the vibration application section while the toner is being transferred from the transfer source member to the transfer destination body.

9. The image forming apparatus of claim 8, wherein the vibration control section varies the frequency of the vibration applied to the transfer member by the vibration application section in a predetermined range which includes a natural frequency of the transfer member to which the vibration is applied by the vibration application section.

10. The image forming apparatus of claim 8, wherein the vibration control section cyclically varies the frequency of the vibration applied by the vibration application section for no less than one cycle between predetermined upper and lower frequencies while the toner transferred from the transfer source member to the transfer destination body passes through a transfer nip portion where the transfer source member and the transfer destination body face each other.

11. The image forming apparatus of claim 8, wherein the vibration application section is positioned on the downstream side of the position where the toner image is transferred from the transfer source member to the transfer destination body.

12. The image forming apparatus of claim 8, wherein the frequency of the vibration is varied in sine curve fashion.

13. The image forming apparatus of claim 8, wherein the frequency of the vibration is varied linearly.

14. The image forming apparatus of claim 9, wherein the vibration control section cyclically varies the frequency of the vibration applied by the vibration application section for no less than one cycle between predetermined upper and lower frequencies while the toner transferred from the transfer source member to the transfer destination body passes through a transfer nip portion where the transfer source member and the transfer destination body face each other.

15. A method of transferring a toner from a first member to a second member, including steps of:
applying vibration to at least one of the first and second members at a timing when the toner is transferred from the first member to the second member; and
cyclically varying a frequency of the vibration in a predetermined range.

16. The method of claim 15, said frequency of the vibration is varied in sine curve fashion.

17. The method of claim 15, said frequency of the vibration is varied linearly.

18. The method of claim 15, said predetermined range includes a natural frequency of the first or second member to which the vibration is applied.
